(19) United States
(12) Patent Application Publication
(10) Pub. No.: US 2011/0123032 A1
(43) Pub. Date: May 26, 2011

(54) SINGLE SOUND TRANSMISSION APPARATUS USING HUMAN BODY COMMUNICATON

(75) Inventors: Hey-Jin Myoung, Seoul (KR); Sung-Weon Kang, Daejeon (KR); Jung-Hwan Hwang, Daejeon (KR); Sung-Eun Kim, Seoul (KR); Kyung-Soo Kim, Daejeon (KR); Jung-Bum Kim, Daejeon (KR); In-gi Lim, Daejeon (KR); Chang-Hee Hyoung, Daejeon (KR); Jin-Kyung Kim, Daejeon (KR); Hyung-II Park, Daejeon (KR); Tae-Wook Kang, Daejeon (KR)

(73) Assignee: Electronics and Telecommunications Research Institute, Daejeon (KR)

(21) Appl. No.: 13/003,256

(22) PCT Filed: Dec. 22, 2008
(86) PCT No.: PCT/KR08/07586

§ 371 Date: Jan. 7, 2011

(30) Foreign Application Priority Data
Jul. 30, 2008 (KR) 10-2008-0074541

(51) Int. Cl. H04R 5/00; H04R 1/40

(52) U.S. Cl. 381/17; 381/151; 381/97

(57) ABSTRACT

Provided is a single sound transmission apparatus using human body communication. The single sound transmission apparatus includes a sound signal generator generating a sound signal of an audio frequency band, a high frequency signal generator generating a high frequency signal having a higher frequency than the audio frequency band, a signal combiner generating a combined signal by combining the sound signal with the high frequency signal, and a signal transmitter varying a phase difference between the combined signal outputted from the signal combiner and the high frequency signal outputted from the high frequency signal generator, and outputting the combined signal and the high frequency signal together to a human body, in order to leave only the sound signal through destructive interference of the high frequency signal of the combined signal, wherein the destructive interference is generated in an ear area of the human body.

### TECHNICAL FIELD

An aspect of the present invention relates to a sound transmission apparatus, and more particularly, to a single sound transmission apparatus using human body communication, which enables a user to hear a sound through human body communication by making contact with the single sound transmission apparatus.

This work was supported by the IT R&D program of MIC/IITA [2006-S-072-03, Controller SoC for Human Body Communications]

### BACKGROUND ART

Human body communication is a technology that removes an electric cable from electronic equipments and transfers a signal through the change in electric energy using the human body instead of the electric cable, based on the principle that the electricity flows through the human body.

In the conventional sound transmission system using the human body as a transfer medium, a sound transmission is achieved in a state where both a transmission apparatus and a reception apparatus are in direct contact with the human body. The transmission apparatus transmits a sound signal, and the reception apparatus receives the signal transmitted from the transmission apparatus and converts the received signal into a signal of a frequency band capable of being sensed by people.

That is, in a conventional sound transmission system, when the transmission apparatus modulates a sound signal to be transferred into a signal which is able to be transmitted through the human body and thereafter transmits the modulated signal through the human body, the reception apparatus disposed to be in contact with an ear area (or a vicinity of ears) of a person receives the signal which is outputted from the transmission apparatus and transmitted through the human body, and converts the received signal into a sound signal of an audio frequency band by demodulating the received signal, thus to provide an audible signal.

However, such a conventional sound transmission system separately includes the transmission apparatus and the reception apparatus, and enables users to hear sounds only when the reception apparatus is in contact with or adjacent to the human body.

### DISCLOSURE OF INVENTION

### Technical Problem

An aspect of the present invention provides a single sound transmission apparatus using human body communication, which enables a user to hear a sound through a simple contact without using an additional reception apparatus.

Another aspect of the present invention provides a single sound transmission apparatus using human body communication, which enables a user to hear a sound with only one single sound transmission apparatus.

### Technical Solution

According to an aspect of the present invention, there is provided a single sound transmission apparatus using human body communication, including: a sound signal generator generating a sound signal of an audio frequency band; a high frequency signal generator generating a high frequency signal having a higher frequency than the audio frequency band; a signal combiner generating a combined signal by combining the sound signal with the high frequency signal; and a signal transmitter varying a phase difference between the combined signal outputted from the signal combiner and the high frequency signal outputted from the high frequency signal generator, and outputting the combined signal and the high frequency signal together to a human body, in order to leave only the sound signal through destructive interference of the high frequency signal of the combined signal, wherein the destructive interference is generated in an ear area of the human body.

The signal transmitter may include: a first signal transmitter varying a phase of the combined signal outputted from the signal combiner, and outputting the varied signal to the human body; and a second signal transmitter varying a phase of the high frequency signal outputted from the high frequency signal generator, and outputting the varied signal to the human body.

The first signal transmitter may include: a first phase shift unit varying a phase of the combined signal outputted from the signal combiner; and a first output unit outputting the combined signal outputted from the first phase shift unit to the human body. When necessary, the first signal transmitter may further include at least one of a first amplification unit performing an amplification for increasing resistance of the combined signal to a noise, and a first calibration unit performing a calibration of the combined signal on the basis of a distance from the human body to the sound transmission apparatus and impedance of the human body.

The second signal transmitter may include: a second phase shift unit varying a phase of the high frequency signal outputted from the high frequency signal generator; and a second output unit outputting the high frequency signal outputted from the second phase shift unit to the human body. When necessary, the second signal transmitter may further include at least one of a second amplification unit performing an amplification for increasing resistance of the high frequency signal to a noise, and a second calibration unit performing a calibration of the high frequency signal on the basis of a distance from the human body to the sound transmission apparatus and impedance of the human body.

The single sound transmission apparatus using human body communication may further include a controller controlling a frequency of the sound signal, a frequency of the high frequency signal and a phase difference between the combined signal and the high frequency signal in view of an ear position and body condition of the human body and impedance matching state between the single sound transmission apparatus and the human body.

### ADVANTAGEOUS EFFECTS

A single sound transmission apparatus using human body communication according to an exemplary embodiment of the present invention enables a user to hear a sound by making contact with only one signal sound transmission apparatus even without an additional reception apparatus.

Moreover, a single sound transmission apparatus using human body communication according to an exemplary embodiment of the present invention enables only a communicating user to receive a sound that is being transmitted, and to obtain a stereophonic sound effect, and also requires no additional reception apparatus, thereby facilitating the full use of the apparatus and the ease of user's behaviors.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates a single sound transmission system using human body communication according to an exemplary embodiment of the present invention;

FIG. 2 is a block diagram of the single sound transmission apparatus of the single sound transmission system according to an exemplary embodiment of the present invention; and

FIGS. 3 to 6 are waveform diagrams for describing an operating method of the single sound transmission apparatus according to an exemplary embodiment of the present invention.

### BEST MODE FOR CARRYING OUT THE INVENTION

Exemplary embodiments of the present invention will now be described in detail with reference to the accompanying drawings. These exemplary embodiments are provided so that this disclosure will be thorough and complete, and will fully convey the concept of the invention to those skilled in the art. The invention may, however, be embodied in many different forms and should not be construed as being limited to the exemplary embodiments set forth herein.

In the accompanying drawings, parts irrelevant to a description of the present invention will be omitted for clarity. Throughout the description, the same and substantially identical parts have the same reference numerals or their serial reference numerals.

Additionally, it will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof unless otherwise defined.

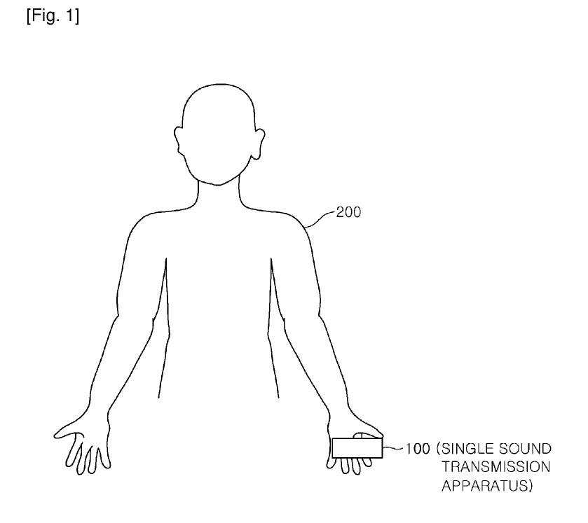

FIG. 1 illustrates a single sound transmission system using human body communication according to an exemplary embodiment of the present invention.

Referring to FIG. 1, a sound transmission system includes a single sound transmission apparatus 100, and a human body 200 that is in contact with (or adjacent to) the single sound transmission apparatus 100.

The sound transmission apparatus 100 simultaneously generates a combined signal of a sound signal and a high frequency signal and another high frequency signal for destructive interference with the high frequency signal included in the combined signal, and thereafter outputs the generated signals to the human body 200 that is in contact with the sound transmission apparatus 100.

The combined signal and the high frequency signal outputted from the sound transmission apparatus 100 are restored to a sound signal through destructive interference in the human body 200 (particularly, an ear area) in the middle of being transferred through the human body 200 used as a communication channel, and the restored sound signal is transferred to the ear area.

Therefore, a person who is in contact with the sound transmission apparatus 100, i.e., a user of the sound transmission apparatus 100 can listen to the sound restored in his ear area even without using an additional reception apparatus.

The combined signal and the high frequency signal outputted from the sound transmission apparatus 100 not only destructively interfere with each other, but also constructively interfere with each other by a superposition of the signals in the human body 200. However, since a signal generated by the constructive interference is a signal exceeding the audio frequency band that users can hear, the users cannot sense the signal generated by the constructive interference.

Accordingly, in an exemplary embodiment of the present invention, only the signal generated by destructive interference will be described without the consideration of the signal generated by the constructive interference, as follows.

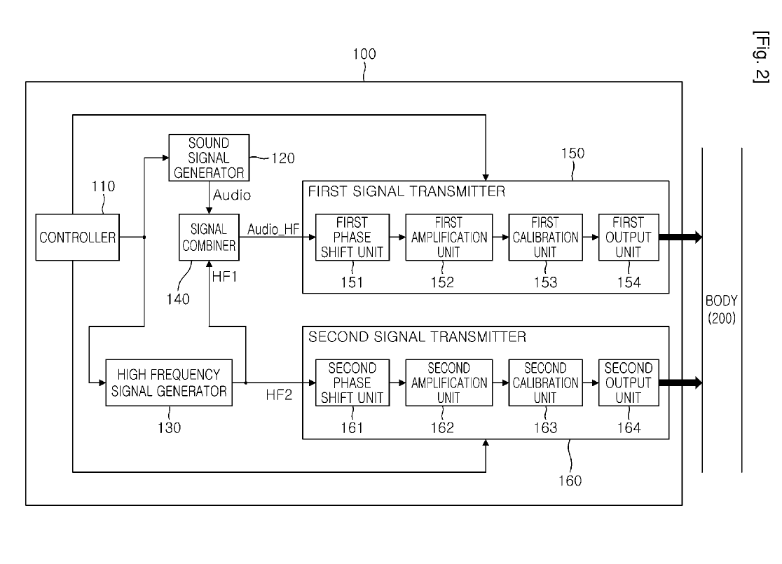

Hereinafter, a configuration of the sound transmission apparatus according to an exemplary embodiment of the present invention will be described in more detail below with reference to FIG. 2.

FIG. 2 is a block diagram of the single sound transmission apparatus of the single sound transmission system according to an exemplary embodiment of the present invention.

Referring to FIG. 2, the sound transmission apparatus 100 according to an exemplary embodiment of the present invention includes a controller 110, a sound signal generator 120, a high frequency signal generator 130, a signal combiner 140, a first signal transmitter 150, and a second signal transmitter 160. The first signal transmitter 150 includes a first phase shift unit 151, a first amplification unit 152, a first calibration unit 153, and a first output unit 154. The second signal transmitter 160 includes a second phase shift unit 161, a second amplification unit 162, a second calibration unit 163, and a second output unit 164.

As shown in FIG. 1, the sound transmission apparatus 100 outputs and transfers a signal through the human body 200 that is in contact with itself, and may be implemented in a hand-held type.

Hereinafter, functions of the respective elements of the single sound transmission apparatus 100 will be described below.

The controller 110 overall controls all the elements of the single sound transmission apparatus 100 so that two signals (i.e., a combined signal Audio_HF of a sound signal Audio and a high frequency signal HF1, and another high frequency signal HF2) can be outputted together, but the high frequency signal HF1 included in the combined signal Audio_HF can destructively interfer with the high frequency signal HF2 and fade at the ear area of the human body 200.

For this purpose, the controller 110 obtains the operation conditions of the single sound transmission apparatus 100, and calculates the phase difference between the combined signal Audio_HF and the high frequency signal HF2, on the basis of the obtained operation conditions, so that the destructive interference can be caused at the ear areas of the human body 200. And, the controller 110 controls frequency generation band of the sound signal generator 120, a frequency generation band of the high frequency generator 130, an amount of phase shift of the first phase shift unit 151 and an amount of phase shift of the second phase shift unit 161 according to the calculation results.

In here, the operation conditions of the single sound transmission apparatus 100 include the body condition and ear position of the human body 200, and the impedance matching state between the single sound transmission apparatus 100 and the human body 200, etc. Therefore, the operation conditions may frequently vary according to the frequently changing operation environments of the single sound transmission apparatus 100.

Moreover, the controller 110 may control signal output speeds of the combined signal Audio_HF and the high frequency signal HF2. This is to provide a stereophonic sound effect by controlling a position of the destructive interference generated in the human body 200 and a generation time of the destructive interference.

The controller 110 extracts the clock information of the sound transmission apparatus 100 and the impedance information of the human body 200 which are stored in an internal memory (not shown) of the sound transmission apparatus 100 to thereby provide the extracted information to the calibration units 153 and 163, and thus enables the calibration units 153 and 163 to perform the calibration operation on signals according to the frequently changing operation environments.

The sound signal generator 120 extracts data, which include information to be transmitted through the human body 200, from a memory under the control of the controller 110, and converts the extracted data into a sound signal Audio of an audio frequency band. Moreover, when necessary, the sound signal generator 120 may receive data from an external communication apparatus to generate a sound signal.

The high frequency signal generator 130 generates the high frequency signals HF1 and HF2 (or an ultrasonic signal) having a higher frequency than an audio frequency band (from 20 Hz to 20 KHz) of people. In this case, the frequencies of the high frequency signals HF1 and HF2 may be changed according to the impedance of the human body 200 and the frequency of the sound signal Audio to be transferred. The high frequency signal HF1 inputted to the signal combiner 140 and the high frequency signal HF2 inputted to the second signal transmitter 160 have the same frequency and phase.

The signal combiner 140 combines the sound signal Audio with the high frequency signal HF1 to generate the combined signal Audio_HF. In this way, the reason that the signal combiner 140 combines the sound signal Audio with the high frequency signal HF1 is to minimize an attenuation of sound wave caused by the internal impedance characteristics of the human body 200 in the middle of transmitting the signals through the human body 200.

The first and second phase shift units 151 and 161 adjust the phase of the combined signal Audio_HF and the high frequency signal HF2 under the control of the controller 110. In this case, the phase difference between the combined signal Audio_HF and the high frequency signal HF2 is frequently varied according to the operation conditions of the single sound transmission apparatus 100. This is to generate the destructive interference of a signal in the ear area of the human body 200, regardless of the frequently changing operation conditions.

A phase shift method of the phase shift units 151 and 161 according to an exemplary embodiment of the present invention may include a general method of changing a signal in an electrical or mechanical manner.

The first and second amplification units 152 and 162 amplify the combined signal Audio_HF and the high frequency signal HF2 to thereby increase an output level. This is to minimize an attenuation of a signal caused by a noise which is injected into the signal when the signal is transmitted trough the human body 200. In this case, the controller 110 controls amplification rates of the amplification units 152 and 162, and thus may more flexibly cope with the changes in communication channel environments according to a skin state and health state of the human body 200 that is in contact with the sound transmission apparatus 100.

The first and second calibration units 153 and 163 perform a calibration of the signals, and thus solve a problem associated with the difficulty to control the quality of sound due to a signal distortion caused by the impedance characteristics of the human body 200. That is, since the impedance of the human body 200 as a communication channel can be frequently changed by various factors such as a change of a portion contacting the sound transmission apparatus 100 and a change of a health state of the human body 200, a calibration must be performed in view of the impedance characteristics of the human body 200.

The first and second output unit 154 and 164 output the combined signal Audio_HF and the high frequency signal HF2 to the human body 200 by making contact with the human body 200, respectively.

In this case, the output units 154 and 164 acoustically couple the sound transmission apparatus 100 with the human body 200. That is, the output units 154 and 164, as a sort of transducers, can transduce a signal to be transmitted into an oscillation signal of transmittable and restorable type, and output the transduced signal to the human body 200.

It has been described that the sound transmission apparatus 100 according to an exemplary embodiment of the present invention includes the first and second calibration units 153 and 163 disposed in a rear portion of the first and second amplification units 152 and 163, and corrects frequency characteristics and input/output characteristics by performing a correction on a signal combined by the signal combiner 140. However, the sound transmission apparatus 100 may be configured to correct an input signal, which is intact before the combination, in the front portion of the signal combiner 140, followed by undergoing the subsequent signal processes. Furthermore, the sound transmission apparatus 100 according to an exemplary embodiment of the present invention may further include elements performing a sensing function, and may allow the elements to measure the distances from the portions of the human body 200, which is in contact with the sound transmission apparatus 100, to left and right ears.

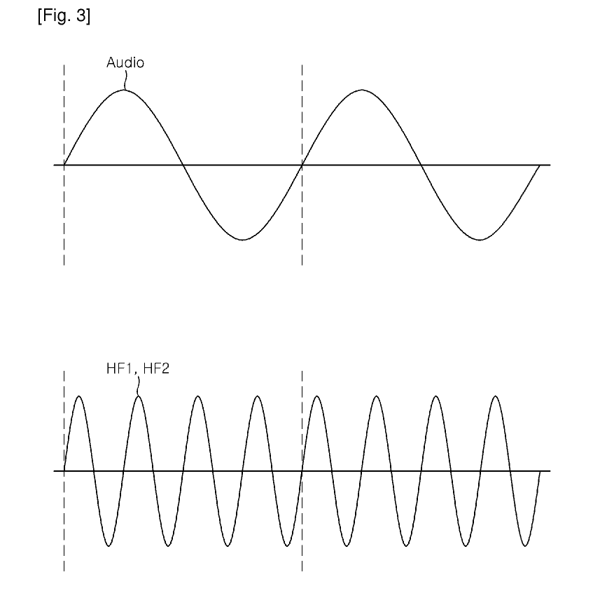

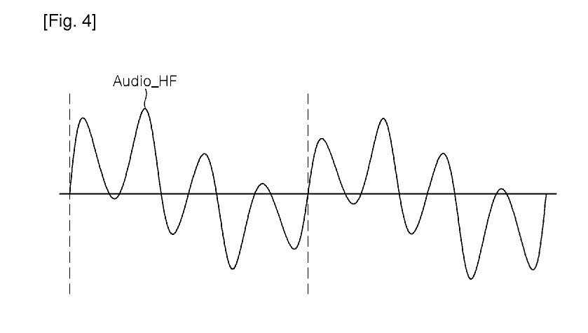

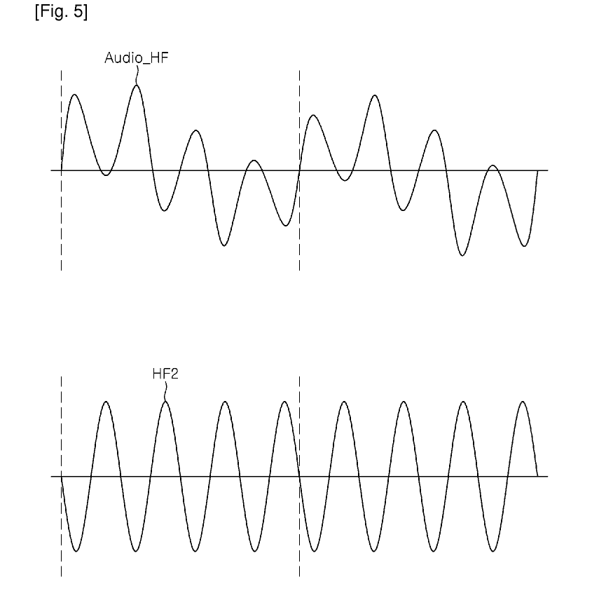

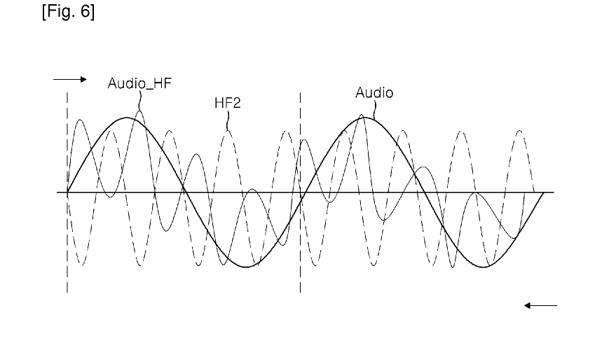

FIGS. 3 to 6 are waveform diagrams for describing an operation method of the single sound transmission apparatus according to an exemplary embodiment of the present invention. FIG. 3 illustrates the sound signal Audio and the high frequency signals HF1 and HF2. FIG. 4 illustrates the combined signal Audio_HF of the sound signal Audio and the high frequency signal HF1. FIG. 5 illustrates the phase-shifted combined signal Audio_HF and the phase-shifted high frequency signal HF2. FIG. 6 illustrates the sound signal Audio restored through the destructive interference of the combined signal Audio_HF and the high frequency signal HF2.

As shown in FIG. 3, the sound transmission apparatus 100 generates the sound signal Audio of an audio frequency band through the sound signal generator 120 and generates the high frequency signals HF1 and HF2 having a higher frequency than that of the sound signal Audio through the high frequency signal generator 130.

As shown in FIG. 4, the sound transmission apparatus 100 combines the sound signal Audio with the high frequency signal HF1 through the signal combiner 140 to generate the combined signal Audio_HF. Subsequently, as shown in FIG. 5, the sound transmission apparatus 100 changes the phase difference between the sound signal Audio and the high frequency signal HF2 through the phase shift units 151 and 161.

To facilitate the transfer of the phase-shifted combined signal Audio_HF and the phase-shifted high frequency signal HF2 through the human body 200, the sound transmission apparatus 100 amplifies and calibrates the phase-shifted combined signal Audio_HF and the phase-shifted high frequency signal HF2 through the amplification units 152 and 162 and the calibration units 153 and 163, and outputs the calibrated signals to the human body 200.

Then, the combined signal Audio_HF and the high frequency signal HF2 collide and destructively interfere with each other in an ear area of the human body 200 in the middle of being transferred through the human body 200. Therefore, as shown in FIG. 6, the high frequency signal HF1 included in the combined signal Audio_HF fades out by means of the high frequency signal HF2, and only the sound signal Audio remains.

Consequently, the human body 200 that is in contact with the sound transmission apparatus 100, i.e., a user of the sound transmission apparatus 100 recognizes the sound signal Audio to thereby hear the sound only by making contact with the sound transmission apparatus 100.

In the above-described exemplary embodiment of the present invention, the combined signal and the high frequency signal destructively interfere with each other in an ear area by controlling the phase difference between the combined signal and the high frequency signal. However, the above-described destructive inference may be generated by controlling a frequency of the sound signal and a frequency of the high frequency signal according to conditions.

For example, in a case where a sound signal to be transmitted has a frequency of f0, the sound signal generator 120 may output a sound signal having a frequency of f0/2, the high frequency signal generator 130 may output a high frequency signal having a frequency of f1, and the signal combiner 140 may output a signal having a frequency of “f0/2+f1” and a signal having a frequency of “f0/2−f1”. Then, the signals are combined in an ear area to generate a combined signal having the frequency of f0, and the combined signal is then transferred to the human body.

As described above, in a state where a sound signal having a desired frequency can be combined through a combination of signals outputted from the sound transmission apparatus 100 that is in direct contact with the human body, any combination of frequencies can be used herein.

While the present invention has been shown and described in connection with the exemplary embodiments, it will be apparent to those skilled in the art that modifications and variations can be made without departing from the spirit and scope of the invention as defined by the appended claims.

### INDUSTRIAL APPLICABILITY

A single sound transmission apparatus using human body communication according to an exemplary embodiment of the present invention enable only a communicating user to receive sound that is being transmitted and to obtain a stereophonic sound effect, and also does not require an additional reception apparatus, thereby facilitating the full use of the apparatus and the ease of user's behaviors.

1. A single sound transmission apparatus using human body communication, comprising:
a sound signal generator generating a sound signal of an audio frequency band;
a high frequency signal generator generating a high frequency signal having a higher frequency than the audio frequency band;
a signal combiner generating a combined signal by combining the sound signal with the high frequency signal; and
a signal transmitter varying a phase difference between the combined signal outputted from the signal combiner and the high frequency signal outputted from the high frequency signal generator, and outputting the combined signal and the high frequency signal together to a human body, in order to leave only the sound signal through destructive interference of the high frequency signal of the combined signal, wherein the destructive interference is generated in an ear area of the human body.

2. The apparatus of claim 1, wherein the signal transmitter comprises:
a first signal transmitter varying a phase of the combined signal outputted from the signal combiner, and outputting the varied signal to the human body; and
a second signal transmitter varying a phase of the high frequency signal outputted from the high frequency signal generator, and outputting the varied signal to the human body.

3. The apparatus of claim 2, wherein the first signal transmitter comprises:
a first phase shift unit varying a phase of the combined signal outputted from the signal combiner; and
a first output unit outputting the combined signal outputted from the first phase shift unit to the human body.

4. The apparatus of claim 3, wherein the first signal transmitter further comprises at least one of:
a first amplification unit performing an amplification to increase resistance of the combined signal to a noise, and
a first calibration unit performing a calibration of the combined signal on the basis of a distance from the human body to the sound transmission apparatus and impedance of the human body.

5. The apparatus of claim 2, wherein the second signal transmitter comprises:
a second phase shift unit varying a phase of the high frequency signal outputted from the high frequency signal generator; and
a second output unit outputting the high frequency signal outputted from the second phase shift unit to the human body.

6. The apparatus of claim 5, wherein the second signal transmitter further comprises at least one of:
a second amplification unit performing an amplification to increase resistance of the high frequency signal to a noise, and
a second calibration unit performing a calibration of the high frequency signal on the basis of a distance from the human body to the sound transmission apparatus and impedance of the human body.

7. The apparatus of claim 1, further comprising a controller determining a frequency of the sound signal, a frequency of the high frequency signal and a phase difference between the combined signal and the high frequency signal according to operation conditions of the single sound transmission apparatus.

8. The apparatus of claim 7, wherein the operation conditions of the single sound transmission apparatus comprises an ear position and body condition of the human body and impedance matching state between the single sound transmission apparatus and the human body.

9. The apparatus of claim 7, wherein the controller provides a stereophonic sound effect by controlling an output speed of the combined signal and an output speed of the high frequency signal.
